(19) United States
(12) Patent Application Publication
(10) Pub. No.: US 2007/0300164 A1
(43) Pub. Date: Dec. 27, 2007

(54) METHOD AND SYSTEM FOR MANAGING INSTANT MESSAGE LOGS FROM WITHIN A CALENDAR APPLICATION

(76) Inventors: KULVIR SINGH BHOGAL, Forth Worth, TX (US); Nizamudeen Ishmael, Austin, TX (US); Mandeep Singh Sidhu, Pflugerville, TX (US)

Correspondence Address: IBM CORP (YA);C/O YEE & ASSOCIATES PC, P.O. BOX 802333, DALLAS, TX, 75380, US

(21) Appl. No.: 11/425,431

(22) Filed: Jun. 21, 2006

(51) Int. Cl. G06F 3/00

(52) U.S. Cl. 715/753

(57) ABSTRACT

A computer implemented method, computer usable program code, and system for managing the logs of instant message sessions. In response to a user opening an instant message session, a calendar application displays an identifier representing the instant message session in the calendar application. The calendar application links the log of the instant message session to the identifier placed in the calendar application upon the user saving the instant message session.

### BACKGROUND OF THE INVENTION

1. Field of the Invention

The illustrative embodiments relate generally to instant messaging. More specifically, the illustrative embodiments relate to a computer implemented method, computer usable program code, and system for managing the logs of instant message sessions within a calendar application.

2. Description of the Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called Transmission Control Protocol/Internet Protocol (TCP/IP).

With respect to transferring data over the Internet, the World Wide Web environment is used. This environment is also referred to simply as “the Web.” The Web is a mechanism used to access information over the Internet. In the Web environment, servers and clients effect data transaction using the hypertext transfer protocol (HTTP), a known protocol for handling the transfer of various data files, such as text files, graphic images, animation files, audio files, and video files.

The Internet has revolutionized communications and commerce, as well as being a source of both information and entertainment. For many users, email is a widely used format to communicate over the Internet. Additionally, the Internet is also used for real-time voice conversations and for instant messaging. Email may be used to input appointments and to set up meetings in calendar applications used by many businesses.

A calendar application is a program that enables the user to record events and appointments on a computer. Calendar applications typically have features such as automatic entries for regular events and reminders that signal the user of an upcoming event. Businesses commonly use calendar applications as schedulers, which enables groups of users connected to a network to coordinate their schedules.

Instant messaging is an online chat medium, allowing users to communicate with each other and to collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users may view each other's availability and may initiate a text conversation with colleagues or customers when a desired contact becomes available. Typically, with instant messaging applications, communications between users are initiated by users selecting the name of the person with whom they desire to communicate. Then, the users type messages in a dialog box in the window and press “send.” These messages appear instantly on the other selected recipient's computer. An instant message session spans the time between the opening of the instant messaging interaction with a particular participant or participants until the instant message interaction is closed. Until now, instant messaging has been developed largely for home users, but currently instant messaging is used by home and business users alike.

As more businesses are using instant messaging, it is becoming more important for users to store logs of the instant message sessions as a record of their interactions. An instant message session log is a file that lists the interactions that have occurred between the instant message participants in a session. Text, hyperlinks, and pictures are all examples of the interactions that are recorded in the instant message session log. Current instant messaging systems are deficient with regard to managing instant message logs. Consider an example of a user who has multiple instant message sessions with supervisors and coworkers over the course of a month. The user saves the logs of these instant message sessions to an instant message session log directory. The directory fills with these individual files. To recall a particular interaction in a particular session, the user must retrieve the log of that instant message session. A problem associated with the typical method of storing the logs of instant message sessions is that the user, when searching the instant message log file directory, has few visual clues as to which is the instant message session log of interest. The user then must search through many instant message session logs to find the session log of interest.

### SUMMARY OF THE INVENTION

The illustrative embodiments provide a computer implemented method, computer usable program code, and system for managing the logs of instant message sessions. In response to a user opening an instant message session, a calendar application displays an identifier representing the instant message session in the calendar application. The calendar application links the log of the instant message session to the identifier placed in the calendar application upon the user saving the instant message session.

### BRIEF DESCRIPTION OF THE DRAWINGS

The novel features believed characteristic of the illustrative embodiments are set forth in the appended claims. A preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the illustrative embodiments may be implemented;

FIG. 2 is a block diagram of a data processing system in which the illustrative embodiments may be implemented;

FIG. 3 is a block diagram illustrating components used in managing instant message logs in accordance with the illustrative embodiments;

FIG. 4 is a diagram illustrating an instant messaging client in accordance with the illustrative embodiments;

FIG. 5 is a flowchart of the actions performed by the user, with the corresponding response from the calendar application in accordance with the illustrative embodiments;

FIG. 6 is an exemplary graphical user interface (GUI) displaying two days of a user's calendar in accordance with the illustrative embodiments; and

FIG. 7 is a schematic diagram depicting user actions from within the calendar display illustrating the calendar application response to the user action in accordance with the illustrative embodiments.

### DETAILED DESCRIPTION OF THE PREFERRED EMBODIMENT

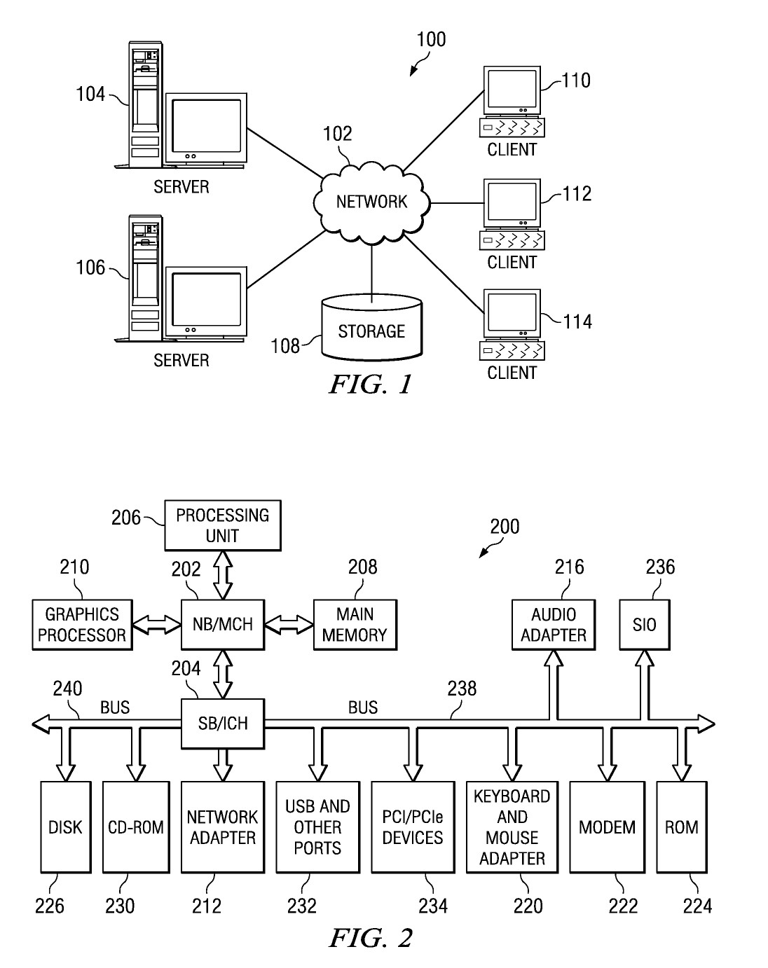

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, computer usable program code, and system for managing the logs of instant message sessions. In particular, the mechanism of the illustrative embodiments allows an instant message user to display identifiers in a calendar application to aid in locating an instant message session log. The identifiers mark the date and time of the instant message session in the calendar display. The identifiers may further provide visual clues as to the content of the interaction in the instant message session log. Illustrative examples of an identifier include a user initiated graphic icon that is a small picture of a participant or a symbol that represents the subject matter of the session.

Further illustrative examples of identifiers describe time blocks that highlight the portion of the user's calendar that spans the instant message session, indicating the duration of the instant message session. This feature may be used in lieu of the use of an icon as the identifier or in conjunction with an icon identifier. Since it is possible to keep an instant message session open for many hours without constant or indeed any interaction, these time blocks may also include lines that represent the interaction between the participants and the user. Each participant's representative lines being depicted in an individualized color or symbol. The length of the representative line indicates the quantity of that interactive communication. In other words, the more the participant types the longer the representative line. This feature is beneficial if a particular detail is sought that is contained in an instant message session that spans for hours. Another option in an illustrative example is to demark important lines of an instant message session with a special color or symbol.

The user may also place information adjacent to the identifier such as a comment as to the subject of the instant message session, a list of participant's names, or further data associated with the participants. The further data associated with the participants may be the name of the company for which the participant works, or an organization to which the participant is a member. In a preferred embodiment, the calendar application locates the further data in the instant messaging application in a contact file. Those of ordinary skill in the art can appreciate that the further data can be obtained in many ways, for example, from a list within a modified calendar application or in a participant profile located on a network such as network data processing system 100, in FIG. 1.

The identifier is linked to the instant message session log such that the user may open the instant message session log by selecting the identifier by a left-click from within the calendar application. A left-click is performed by placing the mouse pointer over the identifier and manipulating the left mouse button.

Further, in a preferred embodiment, the calendar application displays information associated with the log of the instant messaging session when a user rests the mouse pointer over the identifier linked to the log (a mouseover), without the user having to open the instant message session log. Those of ordinary skill in the art will appreciate that the mouseover information associated with the log of the instant messaging session may be accessed in other ways such as a right-click. A right-click is performed by placing the mouse pointer over the identifier and manipulating the right mouse button. In a pop-up display, information such as a preview of the log file, the names of the participants or the association of the participants are displayed. A pop-up display is a window that suddenly appears (pops up) when the user rests the mouse pointer or presses a special function key or right-clicks while the mouse pointer is indicating a particular icon. The pop-up window contains the information associated with the log file only as long as the mouse pointer rests on the identifier. When the user moves the mouse pointer away from the identifier, the pop-up display disappears.

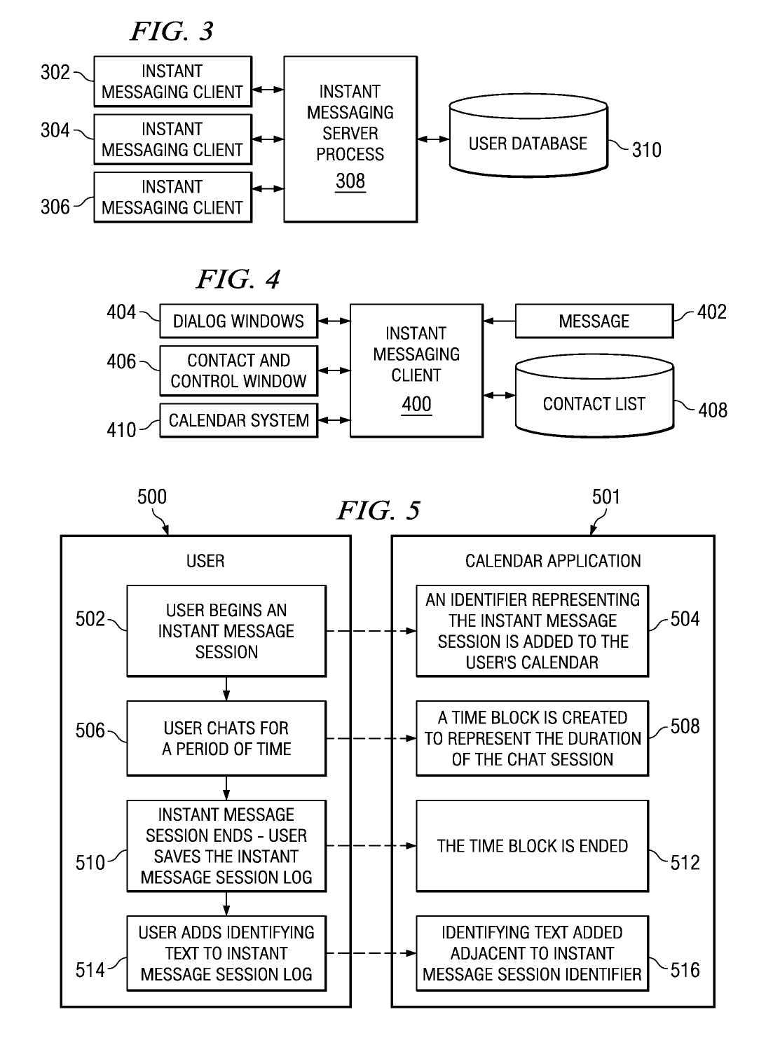

Turning now to FIG. 3, a block diagram illustrating components used in managing instant message logs in accordance with the illustrative embodiments. In this illustrative example, a user at instant messaging client 302 may send or exchange messages with other users at instant messaging clients 304 and 306. These instant messaging clients may be executing on a data processing system, such as data processing system 200 in FIG. 2. The exchange of messages in these examples is facilitated through instant messaging server process 308. This process allows for users to find other users within the instant messaging system as well as aid in the exchange of messages between different users.

Depending on the particular instant messaging system, instant messaging server process 308 may only be involved in providing an indication of when particular users are online and for establishing initial contacts while users contacting users already on a buddy list may contact those users directly after seeing that a particular user is online. Instant messaging server process 308 may be located on a server, such as servers 104 or 106 in FIG. 1.

In these examples, the different users registered to the instant messaging system are stored in user database 310. This user database provides information needed to search for and find other users as well as contact users when they are online.

Turning next to FIG. 4, a diagram illustrating an instant messaging client is depicted in accordance with the illustrative embodiments. The components illustrated in FIG. 4 may be found in an instant messaging client, such as instant messaging client 302, 304, or 306 in FIG. 3. These components may be implemented in a data processing system, such as data processing system 200 in FIG. 2.

In the illustrative example, instant messaging client 400 processes messages, such as message 402, received from users located on remote data processing systems. As messages are received, these messages are presented in dialog windows 404. Additionally, dialog windows 404 provide an interface for a user to input text to send messages to other users.

Contact and control window 406 is presented by instant messaging client 400 to provide the user with a list of user names, as well as other information. Contact and control window 406 also provides an interface to allow a user to set different preferences. For example, the user may set passwords required to access different names used in instant messaging sessions.

Also, a user may employ contact and control window 406 to set other preferences, such as colors and fonts used in instant messaging client 400. These preferences also may include whether a picture is to be sent when a session is initiated with another user. Depending on the implementation, the preference may be set to allow a user who receives messages to retrieve images of the senders from a remote database or a local cache.

Further, a list of names presented by contact and control window 406 is stored in contact list 408 in these examples. Additional user or screen names may be added to or deleted from contact list 408. This contact list is employed in presenting the list of names within contact and control window 406.

Calendar system 410 may be integrated into instant messaging client 400 in various ways. For instance, calendar system 410 may be a personal calendaring system, such as Lotus Notes® or Microsoft Outlook®, that is connected to instant messaging client 400 via a plugin or adapter. The mechanism of the illustrative embodiments may use the calendaring system's existing application programming interface (API) to enable the instant messaging client to create entries in the calendar. A separate adapter may be created for each calendaring system.

In another example, calendar system 410 may also be built within the instant messaging client itself. In this case, the instant messaging client may mimic the capabilities of traditional calendaring systems by displaying selectable month/day/year and time options to the user, or alternatively, the instant messaging client may interpret specific syntax the user types into the instant message window as a request to display an identifier for an instant message session. Existing instant messaging clients have the capability to intercept text and handle the text as commands. Thus, when a user's instant messaging client sends text to a contact, the contact's instant messaging client may intercept the text not as text to be displayed to the user, but rather as commands to invoke the identifying mechanism of the illustrative embodiments. The user's instant messaging client may then handle adding the instant message session log identifier to the user's calendar. Alternatively the calendar system may be modified to handle instant message log files in a manner similar to the handling methods of appointments and other events, and displaying the identifier on the calendar display page.

Referring now to FIG. 5, a flowchart of the actions performed by the user, with the corresponding response from the calendar application in accordance with the illustrative embodiments. User area 500 indicates actions the user takes and calendar application area 501 indicates actions the calendar application takes in response. The user begins by opening an instant message session (step 502). The user may initiate the instant messaging session or begin by responding to a session initiated by a participant. A participant is another entity taking part in the instant message session, most typically a person on the user's contact list such as contact list 408 in FIG. 4. In response the calendar application displays an identifier representing the instant message session. The identifier is displayed at the time and date of the instant message session in the user's calendar display (step 504). The identifier may be an icon associated with the instant message service provider, an icon initiated by the user, such as clip art or a small picture of the participant, or an instant message session block, in accordance with the illustrative embodiments. The calendar application may use any or all of the identifiers, as selected by the user or in the case of the time block, automatically initiated by the calendar application after a user selectable period of time.

To create the calendar highlighted block of time, the user chats for a selectable period of time (step 506). The selectable period of time may span from minutes to days. The selectable period of time may be preselected by the user or the user may determine during the instant message session that a highlighted time block is desired and then select the option. In either example, the calendar application highlights a block of time on the calendar display to represent the duration of the instant message session (step 508). The instant message time block is a shaded or marked area of the calendar display that represents the duration as well as the date and time of the instant message session occurrence. At the conclusion of the instant message session, the user saves the log of the instant message session (step 510). In response, the instant message block on the calendar display ends by ending the shaded portion of the date and time calendar display (step 512).

The user may optionally add text or graphics to further identify the log of the instant message session (step 514). The further added text is displayed adjacent to the identifier in the calendar display (step 516).

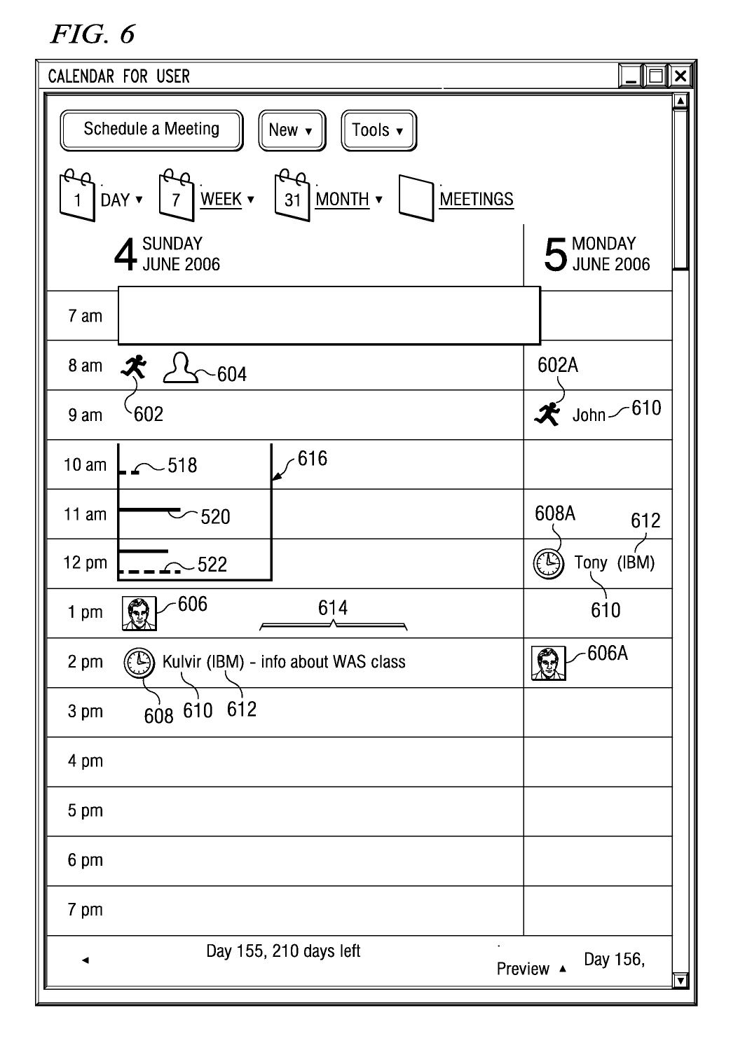

Turning now to FIG. 6, an exemplary graphical user interface (GUI) displaying two days of a user's calendar in accordance with the illustrative embodiments. Each identifier 602, 604, 616, 606, 608, 602A, 608A, or 606A represents a unique instant message session log. Identifier 602 denotes an icon representing an AOL® log of the instant message session. AOL® is a registered trademark of America Online, Incorporated, a division of Time Warner Incorporated. Identifier 604 denotes an icon representing an MSN® log of the instant message session. MSN® is a registered trademark of MSN Internet Services, a division of Microsoft Corporation. Identifier 606 denotes an icon representing a Yahoo! Messenger® session. Yahoo! Messenger® is a registered trademark of Yahoo! Incorporated. In the illustrative examples, the calendar application may set the default identifier to be the icon of the instant message service provider. Instead of the service provider icon, the user may initiate other custom icons, such as clip art, which serves to denote a log of the instant message session. Identifier 608 is a user initiated icon created from a picture.

More information may be added to identify the log of the instant message session. This additional information is displayed adjacent to the identifier in the calendar display. Examples of such information include instant message session participant names 610, and participant data 612 with which the participant or participants are associated. Instant message session participant names 610 shown in this illustrative example are John, Tony, and Kulvir. An example of participant data is the group name of the participant. A group name refers to the company or other affiliation of the participant. The group name may be found in the instant message application contact list as contact list 408 in FIG. 4 or elsewhere on the user's network. An example of participant data 612 is IBM®. IBM® is a registered trademark of International Business Machines Corporation. In addition, clarifying comments may be added to aid in identifying the log of the instant message session, such as comment 614, “Info about WAS class.”

In this illustrative example, instant message log time block 616 is used to denote a recorded instant message session that occurred on Sunday, Jun. 4, 2006. The example instant message session started at 9:15 am and lasted until 12:15 pm. This time block “image” that represents the conversation from 9:15 am to 12:15 pm may also have markings to represent the instant message participant interaction. For example, solid black lines 620, and 622 are text conversation from the user, while dashed lines 618, and 622 is text conversation from a participant of the session. Long lines 620, and 622 represent a long paragraph in the session. A session with multiple participants may have different colors or symbols to represent each person. Also, parts of the instant message that are noted as “important” may be represented in “red” or in another user chosen color or symbol. Other user configurable distinctive markings such as dashed or dotted lines may be used alternatively or in conjunction with color lines to make the lines distinguishable.

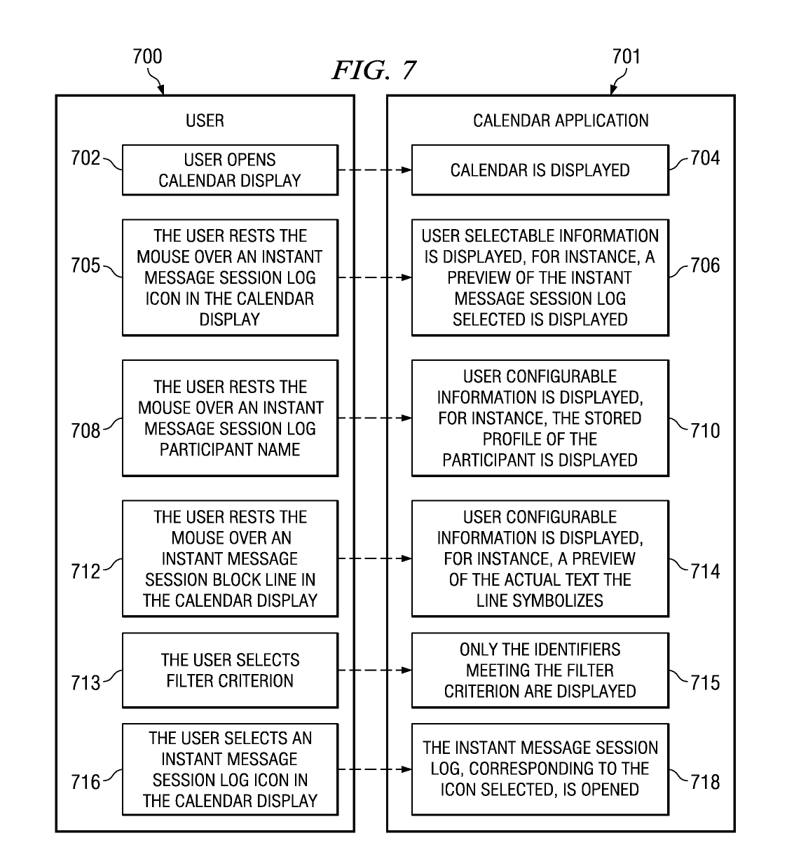

Turning now to FIG. 7, a schematic diagram depicting user actions from within the calendar display illustrating the calendar application response to the user action in accordance with the illustrative embodiments. User initiated actions are shown in user area 700. Calendar application actions in response are shown in calendar application area 701. The user opens the calendar display (step 702). The calendar application opens a calendar display, such as the calendar display shown in FIG. 6 (step 704). To gather more information about the log of the instant message sessions that are illustrated on the display page, the user may rest the mouse pointer over an instant message session log identifier in the calendar display (step 705). The calendar application responds by displaying user selectable information (step 706). For example, a preview of the log of the instant message session may be displayed. A preview of the instant message log shows a portion of the instant message session log without opening the instant message session log file. Other user selectable information that may be displayed is a list of the instant message session participants.

The user may rest the mouse pointer over an instant message session log participant's name (step 708). The calendar application responds by showing the profile of the instant message session participant (step 710). The profile may be previously stored in the calendar application in an illustrative embodiment or the profile of the instant message session participant may be stored in an instant message contact list such as contact list 408 in FIG. 4.

The user may also rest the mouse pointer over an instant message session time block line such as line 622 in FIG. 6 in the calendar display (step 712). The calendar application responds by showing a preview of the text that the time block line symbolizes (step 714).

A filter application may also be implemented that allows a user to only view instant message session log identifiers that meet the selected criterion. The user selects a filter criterion using, in an illustrative embodiment, a drop down menu (step 713). A drop down menu is a menu of options that appears below the item when the user clicks on it. The drop down menu may list such filter criteria as, participant names, group information and time of day of the instant message sessions. In response, the calendar application will cause all the other identifiers to be removed from the calendar display except those instant message session log identifiers that meet the filter criteria (step 715). For example, if the user selects John as a filter criterion, the calendar would display only the identifiers that link to instant message sessions logs that include John as a member.

The user may elect to open the log of the instant message session by left-clicking on the identifier of the log of the instant message session (step 716). Those of ordinary skill in the art can appreciate that the user may select and open the log of the instant message session using other keys or methods. The user left-clicks on an identifier, for example the identifier, icon 604 of FIG. 6. The calendar application responds by opening the file linked to this identifier (step 718).

Thus, the advantages provided by the mechanism of the illustrative embodiments over current instant messaging systems include enabling an instant message user to find and organize instant message session logs using identifiers on a calendar display page. In searching for a particular instant message session log, the user may target a certain participant or group association and filter out all other identifiers in the calendar display easing the user's task of locating a particular instant message session log. The user may then open the log of the instant message session by selecting the identifier from within the calendar application.

The invention may take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system. For the purposes of this description, a computer-usable or computer readable medium may be any tangible apparatus that may contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of an illustrative embodiment has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing logs of instant message sessions within a context of a calendar application, the computer implemented method comprising:
responsive to a user opening an instant message session, displaying an identifier representing the instant message session in the calendar application; and
responsive to the user saving a log of the instant message session, linking the log of the instant message session to the identifier in the calendar application.

2. The computer implemented method of claim 1, further comprising:
responsive to the user selecting the identifier placed in the calendar application, displaying the log of the instant message session to the user.

3. The computer implemented method of claim 1, further comprising:
displaying information associated with the log of the instant message session in response to the user resting a mouse pointer over the identifier.

4. The computer implemented method of claim 3, wherein the information includes at least one of a preview of the log, a participant list, or additional participant data.

5. The computer implemented method of claim 1, wherein the identifier is an icon representing a messaging service provider that is providing the instant message session.

6. The computer implemented method of claim 1, wherein the identifier is a user initiated graphic icon.

7. The computer implemented method of claim 1, wherein the identifier is a time block representing a duration of the instant message session in the calendar application.

8. The computer implemented method of claim 7, wherein the time block includes a plurality of lines, and wherein each line in the plurality of lines represents an instant message text of each participant in the instant messaging session.

9. The computer implemented method of claim 8, wherein a length of a line in the plurality of lines represents a length of the instant message text.

10. The computer implemented method of claim 8, wherein the instant message text is depicted as important by displaying the line associated with the instant message text in a particular color.

11. The computer implemented method of claim 1, wherein names of participants in the instant messaging session are displayed adjacent to the identifier in the calendar application.

12. The computer implemented method of claim 1, wherein additional participant data is located in an instant messaging application interface, and wherein the additional participant data is displayed adjacent to the identifier in the calendar application.

13. The computer implemented method of claim 1, further comprising:
displaying only the logs of the instant message sessions which meet a filter criterion.

14. The computer implemented method of claim 13, wherein the filter criterion includes at least one of a name of a participant, additional participant data, or a date.

15. A computer program product comprising:
a computer usable medium including computer usable program code for managing the logs of instant message sessions, the computer program product comprising:
computer usable program code for displaying an identifier representing an instant message session in a calendar application in response to a user opening an instant message session; and
computer usable program code for linking a log of the instant message session to the identifier placed in the calendar application in response to the user saving the log of the instant message session.

16. The computer program product of claim 15, further comprising:
computer usable program code for opening the log of the instant message session in response to the user selecting the identifier.

17. The computer program product of claim 15, wherein the identifier is a user initiated graphic icon.

18. The computer program product of claim 15, wherein the identifier is a time block representing a duration of the instant message session in the calendar application.

19. A data processing system comprising:
a bus system;
a communications system connected to the bus system;
a memory connected to the bus system, wherein the memory includes a set of instructions; and
a processing unit connected to the bus system, wherein the processing unit executes the set of instructions to display an identifier representing an instant message session in a calendar application in response to a user opening the instant message session, and link a log of the instant message session to the identifier placed in the calendar application in response to the user saving the log of the instant message session.

20. The data processing system of claim 19, wherein the set of instructions further comprises:
opening the log of the instant message session in response to the user selecting the identifier.
